(19) United States
(12) Patent Application Publication
(10) Pub. No.: US 2005/0128537 A1
(43) Pub. Date: Jun. 16, 2005

(54) Carrying apparatus for holding optical scanning module

(76) Inventor: Ying-Qi Zhu, Jiu-Chang (CN)

Correspondence Address: RABIN & Berdo, PC, 1101 14TH STREET, NW, SUITE 500, WASHINGTON, DC, 20005, US

(21) Appl. No.: 11/008,181

(22) Filed: Dec. 10, 2004

(30) Foreign Application Priority Data
Dec. 11, 2003 (TW) 92135089

(51) Int. Cl. H04N 1/04

(52) U.S. Cl. 358/497; 358/486; 358/487

(57) ABSTRACT

A carrying apparatus for holding an optical scanning module is provided to allow the optical scanning module against the platen. The carrying apparatus at least comprises the first carriage, the second carriage and a carriage control means. The second carriage is pivotably connected to the first carriage. The carriage control means provides an upward force to lift one or both of the first carriage and the second carriage up, thereby allowing the optical scanning module loaded on the carriages against the platen.

This application claims the benefit of Taiwan application Serial No. 92135089, filed Dec. 11, 2003, the subject matter of which is incorporated herein by reference.

### BACKGROUND OF THE INVENTION

1. Field of the Invention

The invention relates in general to a carrying apparatus for holding optical scanning module, and more particularly to the carrying apparatus having an adjusting means for adjusting the position of the optical scanning module, so as to lift the optical scanning module up and against the platen during the scanning operation.

2. Description of the Related Art

In the age of high technology, scanner has been required in the modern life due to its great functions of scanning the original drafts, such as the pictures, the photos and the documents, and then transforming and saving the image as the digital files. It provides a very convenient way for the users to keep or find the original drafts. The mechanical devices contained in the scanner are briefly described below.

A conventional optical scanner has a transparent platen for placing an original to be scanned document. A moving carriage assembly and the drive mechanisms are positioned underneath the transparent platen. The moving carriage assembly, including an optical scanning module supported by a carrying apparatus (also called “carriage” hereinafter), contains the optical and electronic or reflective components, and moves across the complete length of the document during scanning. The components commonly used for the carriage assembly are the light source, the reflector, the lens and the photo-electronic sensing device. Drive mechanisms for moving the carriage assembly are varied. During scanning, the light emitted from the light source is reflected by the original to be scanned document, and then further reflected by the lens and focused on the photo-electronic sensing device by the lens. Afterward, the light signal received by the photo-electronic sensing device is converted into electronic signals, and then produce machine-readable data, which is representative of the image of the original document. The photo-electronic sensing device can be any device capable of converting the light signal into the electric signal, such as charged coupled device (CCD) or contact image device (CIS).

During scanning, the carriage assembly is required to move against the transparent platen, particularly the carriage assembly using contact image device (CIS) (which has a short scene depth of about 0.3 mm) as the photo-electronic sensing device. FIG. 1 is an explosive view schematically showing a conventional structure of the contact image device (CIS) module and the carrying apparatus. The transparent platen 1 is used for placing an original to be scanned document. Under the transparent platen 1, the optical scanning module 2 is loaded in the carriage 4 which is positioned on a shaft (not shown) by a connecting means 6, and the drive mechanism (not shown) drives the carriage 4 to move along the scanning direction on the shaft. Also, a spring 8 is interposed between the optical scanning module 2 and the carriage 14. The spring 8 provides an upward elastic force to lift the optical scanning module 2 up until contacting the bottom surface of the transparent platen 1, thereby making the optical scanning module 2 moving against the transparent platen 1 during scanning operation.

As be known, the degree of fidelity with which the information presented by the to be scanned document is recorded depends on the accuracy with which the moving carriage assembly is guided during the scanning operation. The reproduction is liable to be impaired even by small changes in either the direction of relative scanning movement or the spacing between the document and the optical scanning module 2 from one moment to another in the scanning operation. The conventional design with a spring 18 between the scanning apparatus and the carriage, however, is difficult to keep the optical scanning module 2 in balance, particularly in a scanning movement. It is also difficult to precisely and firmly locate the spring 18 at the center of the carriage 4. In practice it would be desirable to design not only an easy to be assembled but also a more reliable and stable structure to lift the scanning module up for contacting with the platen, thereby obtaining an optimal scanning image result with a high standard of accuracy.

### SUMMARY OF THE INVENTION

It is therefore an object of the invention to provide a carrying apparatus for holding the optical scanning module. The carrying apparatus having an adjusting means generates an upward force to rotate the carriages, thereby lifting the optical scanning module up and against the platen during the scanning operation.

The invention achieves the objects by providing an adjusting means disposed on a carrying apparatus for holding an optical scanning module. The adjusting means comprises a first coupling portion, formed on a first carriage of the carrying apparatus; a second coupling portion, formed on a second carriage of the carrying apparatus, and the first coupling portion and the second coupling portion are pivotably connected; and an elastic device, connected to at least one of the first carriage and the second carriage, for providing an elastic force to make the first carriage and the second carriage rotate relatively. The elastic device could be the plate spring, torsion spring, or the idle pulley apparatus having an elastic force.

According to the object of the invention, a carrying apparatus disposed in a scanner for holding an optical scanning module is provided. The carrying apparatus at least comprises a first carriage; a second carriage pivotably connected to the first carriage; and a carriage control means, providing an upward supporting force to the fist carriage, thereby lifting the optical scanning module upward and against the platen during a scanning operation. The carriage control means could be the plate spring, torsion spring, or the idle pulley apparatus having an elastic force.

According to the object of the invention, a scanner capable of adjusting the position of the optical scanning module is further provided. The scanner comprises a platen for placing a to-be-scanned document; an optical scanning module, disposed under the platen for scanning and acquiring an scanned image of the to-be-scanned document; and a carrying apparatus for holding the optical scanning module and moving backward and forward in the scanner. The carrying apparatus at least comprises a first carriage; a second carriage, pivotably connected to the first carriage; and a carriage control means, providing an upward supporting force to the fist carriage, thereby lifting the optical scanning module upward and against the platen during a scanning operation.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) is an explosive view schematically showing a conventional structure of the contact image device (CIS) module and the carrying apparatus;

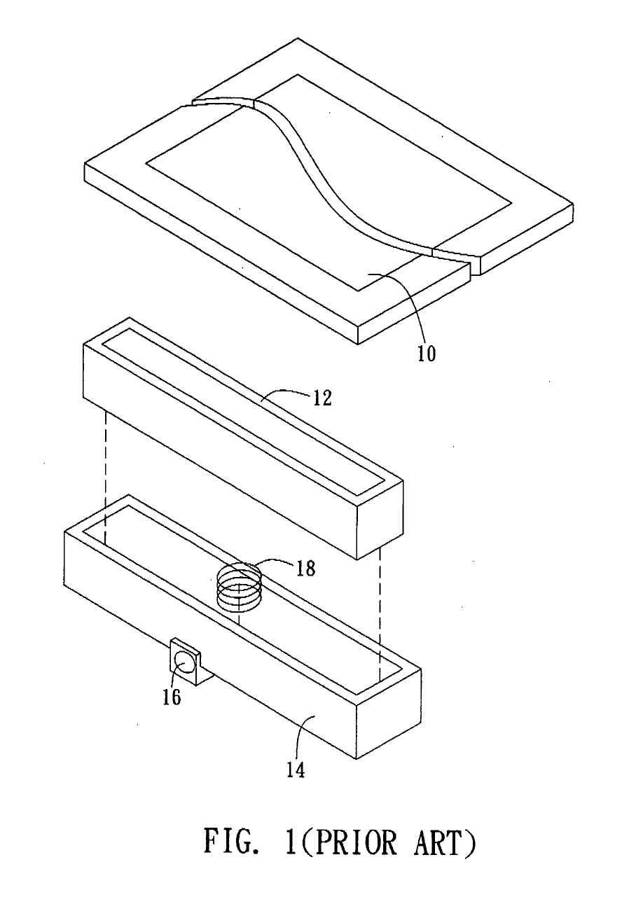

FIG. 2A schematically illustrates a disassembled view of the carrying apparatus and the optical scanning module according to the first embodiment of the invention;

FIG. 2B schematically illustrates a bottom view of the assembled carrying apparatus of FIG. 2A;

FIG. 2C is an enlarged view of an adjusting means shown in FIG. 2B;

FIG. 2D is a cross-sectional diagrammatic side view of the optical scanning module loaded into the carrying apparatus of FIG. 2A;

FIG. 3A schematically illustrates a disassembled view of the carrying apparatus and the optical scanning module according to the second embodiment of the invention;

FIG. 3B is an enlarged bottom view of an adjusting means of the assembled carrying apparatus of FIG. 3A;

FIG. 4 schematically illustrates a disassembled view of the carrying apparatus and the optical scanning module according to the third embodiment of the invention; and

FIG. 5 schematically illustrates a disassembled view of the carrying apparatus and the optical scanning module according to the fourth embodiment of the invention.

### DETAILED DESCRIPTION OF THE INVENTION

In the present invention, a carrying apparatus for holding the optical scanning module is mechanically constructed by using an adjusting means having the carriage control means. Two carriages pivotably connected are rotated upward by the carriage control means, thereby lifting the optical scanning module up and against the transparent platen. The carriage control means disclosed in the embodiments includes a plate spring, a torsion spring and an idle pulley apparatus having idle pulley spring. The detail structures of the adjusting means in the embodiments are slightly different and constructed according to the carriage control means in use.

There are four embodiments disclosed herein for illustrating the invention, but not for limiting the scope of the invention. Additionally, the drawings used for illustrating the embodiments of the invention only show the major characteristic parts in order to avoid obscuring the invention. Accordingly, the specification and the drawing are to be regard as an illustrative sense rather than a restrictive sense.

First Embodiment

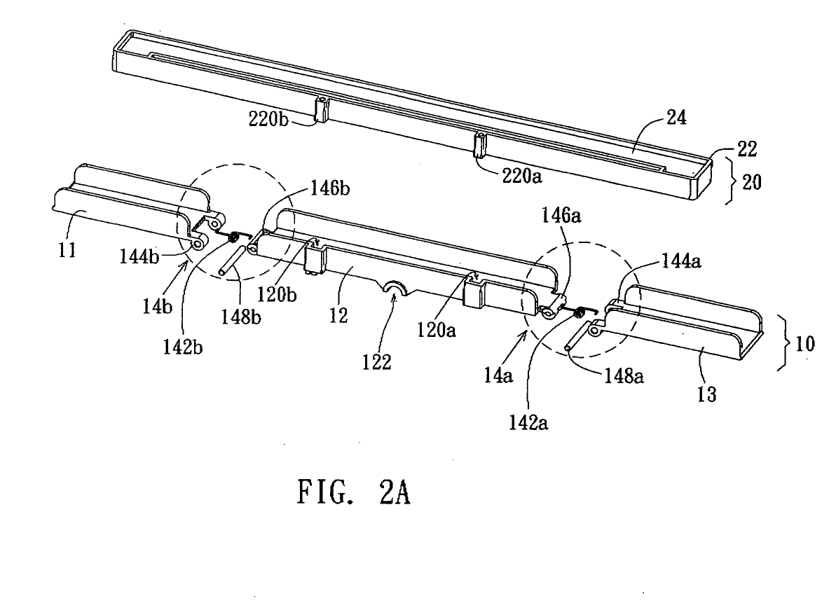

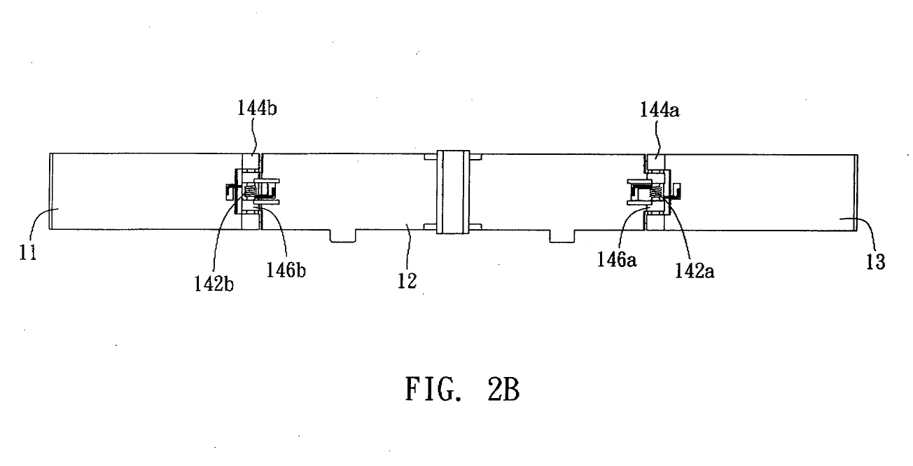

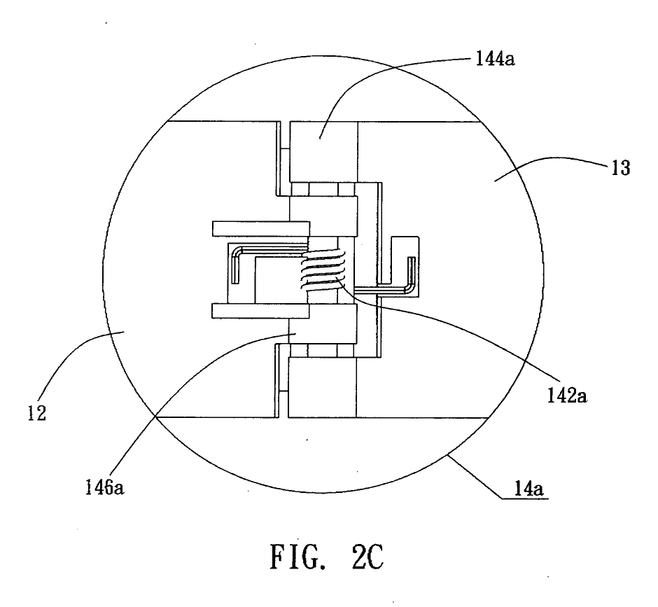

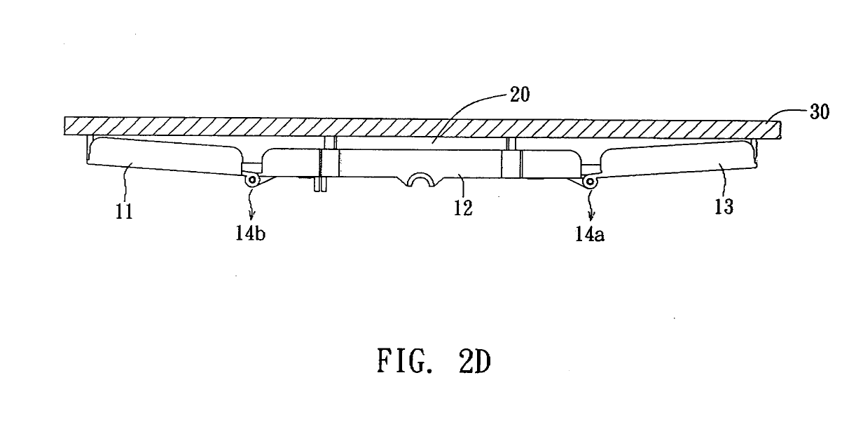

FIG. 2A schematically illustrates a disassembled view of the carrying apparatus and the optical scanning module according to the first embodiment of the invention. In a scanner, the carriage (carrying apparatus) 10 is provided for carrying the optical scanning module 20. The carrying apparatus 10 includes the first carriage such as a carriage-left (carriage-L) 11, the second carriage such as a carriage base 12, and the third carriage such as a carriage-right (carriage-R) 13. The carriage-L 11 and the carriage-R 13 are rotatably connected to the ends of the carriage base 12 by the adjusting means 14b and 14a, respectively. Also, by mounting the groove 122 (formed on the bottom surface of the carriage base 12 and having a half-circular cross section) on the guiding shaft (not shown in FIG. 2A), the carrying apparatus 10 is capable of being moved backward and forward along the scanning direction.

For example, the adjusting means 14a includes a torsion spring 142a, and a rotation part comprising a first coupling portion 144a, a second coupling portion 146a and an axial rod 148a. Noted that the torsion spring 142a is used as a carriage control means in the first embodiment. During assembling, the axial rod 148a inserts through the holes of the first coupling portion 144a, the second coupling portion 146a and the curly part of the torsion spring 142a. The adjusting means 14b and 14a are symmetrically arranged on the carrying apparatus 10; also, both of them have the same mechanical components.

FIG. 2B schematically illustrates a bottom view of the assembled carrying apparatus of FIG. 2A. FIG. 2C is an enlarged view of an adjusting means shown in FIG. 2B. After assembling, the torsion spring 142a mounting on the axial rod 148a touches the carriage base 12 and carriage-R 13 by two ends (i.e. the carriage base 12 and carriage-R 13 are subjected to the elastic force of the torsion spring 142a), so that a relative rotation between the carriage-R 13 and the carriage base 12 is generated. The function of the torsion spring 142b is similar to that of the spring 142a. The torsion spring 142b mounting on the axial rod 148b touches the carriage base 12 and carriage-L 11 by two ends (i.e. the carriage base 12 and carriage-L 11 are subjected to the elastic force of the torsion spring 142b), so as to make a relative rotation between the carriage-L 11 and the carriage base 12.

FIG. 2D is a cross-sectional diagrammatic side view of the optical scanning module loaded into the carrying apparatus of FIG. 2A. When the optical scanning module 20 is loaded into the carrying apparatus, the carriage-L 11 and the carriage-R 13 assembled on the both sides of the carriage base 12 will be forced to moved upward due to the torsions of the torsion springs 14b and 14a, thereby lifting the optical scanning module 20 up and against the transparent platen 30.

A fixing means could be further used for maintaining the position of the optical scanning module 20 on the carrying apparatus 10. As shown in FIG. 2A, the optical scanning module 20 has a housing 22 for protecting the image-capture components 24 (such as the light source and the photo-electronic sensing device). The ribs 220a and 220b are formed on the housing 22 of the optical scanning module 20, and the notches 120a and 120b are relatively configured on the sidewall of the carriage base 12. When the optical scanning module 20 is loaded into the carrying apparatus 10, the ribs 220a and 220b insert into the notches 120a and 120b, respectively, for preventing the slide of the optical scanning module 20.

It is, of course, understood that a number of the ribs and the notches (or only one set of the rib and the notch) could be configured without interfering the movement of the carrying apparatus 10, and the locations of the ribs and the notches could be exchanged (i.e. the ribs and the notches respectively formed on the carriage base 12 and the housing 22) for maintaining the position of the optical scanning module 20. Other types of fixing means could be used to maintaining the position of the optical scanning module 20, too.

Moreover, only one adjusting means in this embodiment could be constructed to achieve the object of the invention. For, example, the carriage-L 11 and the carriage-R 13 could be pivotably connected by the adjusting means 14a (or 14b), and the torsion of the torsion spring 142a (or 142b) provides a supporting force upwardly to the carriage-L 11 and the carriage-R 13.

Second Embodiment

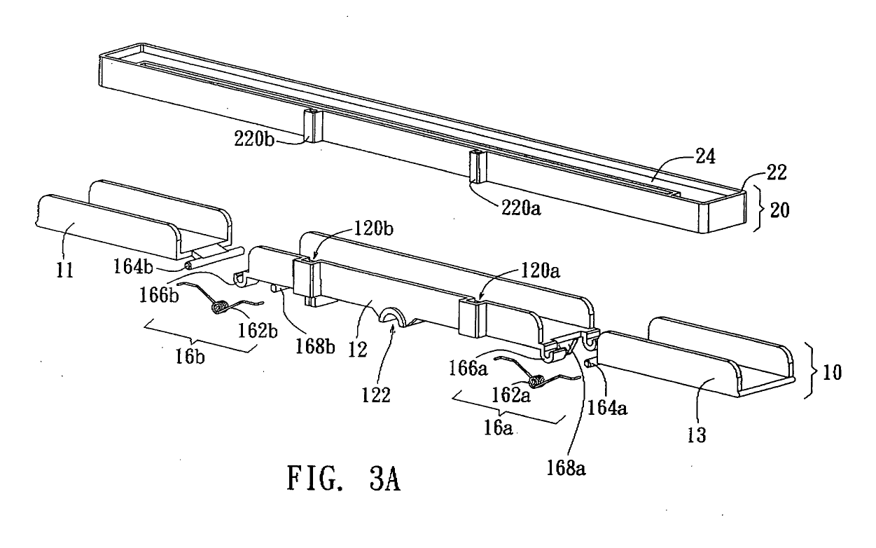

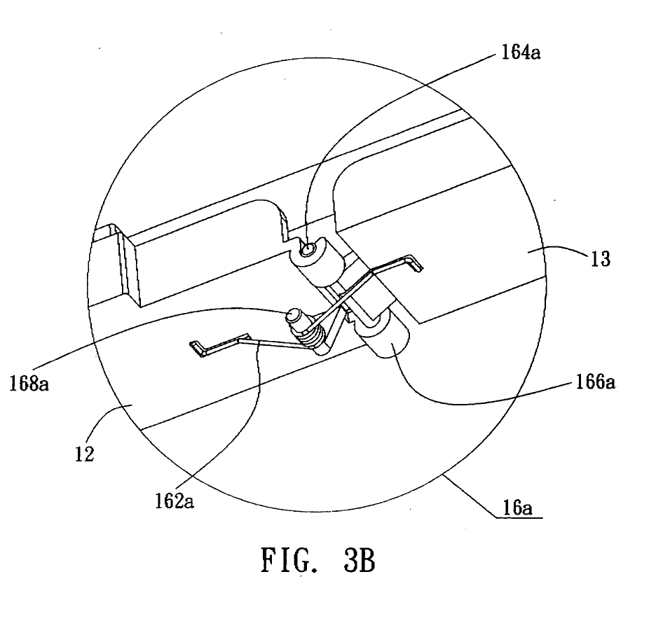

FIG. 3A schematically illustrates a disassembled view of the carrying apparatus and the optical scanning module according to the second embodiment of the invention. Components common to both FIG. 2A and FIG. 3A retain the same numeric designation. The carrying apparatus 10 of the second embodiment is substantially identical to that of the first embodiment, except the pivoting way between the carriage pieces.

In the second embodiment, the carrying apparatus 10 includes the first carriage such as a carriage-left (carriage-L) 11, the second carriage such as a carriage base 12, and the third carriage such as a carriage-right (carriage-R) 13. By mounting the groove 122 (formed on the bottom surface of the carriage base 12 and having a half-circular cross section) on the guiding shaft (not shown in FIG. 3A), the carrying apparatus 10 is capable of being moved backward and forward along the scanning direction. The torsion spring is also used as the carriage control means. The carriage-L 11 and the carriage-R 13 are rotatably connected to the ends of the carriage base 12 by the adjusting means 16b and 16a.

The adjusting means 16a includes a torsion spring 162a, a pivoting shaft 164a, a coupling portion 166a and a fixing pin 168a. The adjusting means 16b includes a torsion spring 162b, a pivoting shaft 164b, a coupling portion 166b and a fixing pin 168b alike. The fixing pins 168a and 168b are disposed on the bottom surface of the carriage base 12. FIG. 3B is an enlarged bottom view of an adjusting means of the assembled carrying apparatus of FIG. 3A. Take the adjusting means 16a for illustration, the pivoting shaft 164a is rotatably engaged with the coupling portion 166a, and the torsion spring 162a is mounted on the fixing pin 168a. After assembling, two ends of the torsion spring 162a touch the carriage base 12 and carriage-R 13 (i.e. the carriage base 12 and carriage-R 13 are subjected to the torsional force of the torsion spring 162a), so that a relative rotation between the carriage-R 13 and the carriage base 12 can be generated. The torsion spring 162b functions in the same manner as the torsion spring 162a, so as to make a relative rotation between the carriage-L 11 and the carriage base 12.

Referring again to FIG. 3A, the ribs 220a and 220b formed on the housing 22 of the optical scanning module 20 can be relatively inserted into the notches 120a and 120b configured on the carriage base 12, for preventing the optical scanning module 20 from sliding. It is, of course, understood that the position and number of the rib-notch sets could be varied without interfering the movement of the carrying apparatus 10. Additionally, only one adjusting means could be constructed in this embodiment (for example, an adjusting means pivotably connects the carriage-L 11 and the carriage-R 13) to achieve the object of the invention.

According to the descriptions above, the torsion springs 142a, 142b, 162a and 162b are used as the carriage control means; the torsion thereof provides the upward supporting force to the carriage-L 11 and the carriage-R 13.

Third Embodiment

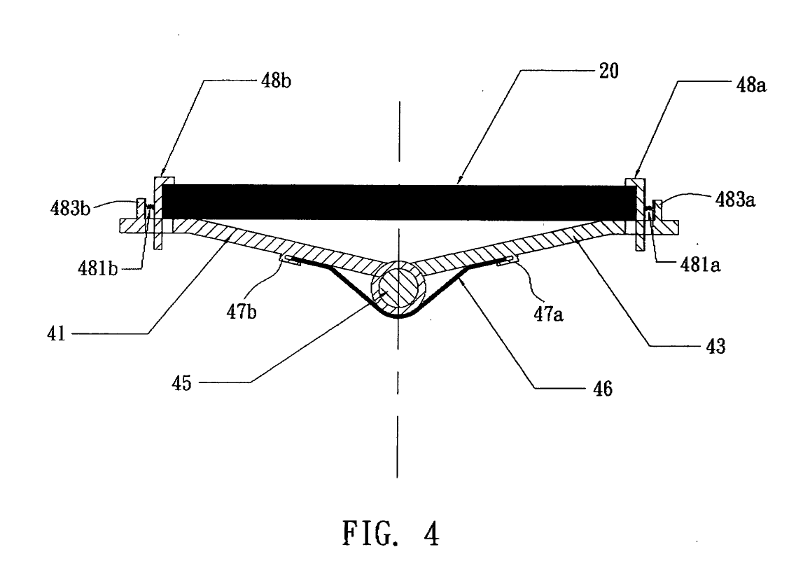

FIG. 4 schematically illustrates a disassembled view of the carrying apparatus and the optical scanning module according to the third embodiment of the invention. In the third embodiment, the carrying apparatus 10 includes the first carriage such as a carriage-left (carriage-L) 41, and the second carriage such as a carriage-right (carriage-R) 43. The plate spring is used as the carriage control means. After assembling, the carriage-L 41 and the carriage-R 43 are rotatably mounted on the guiding shaft 45, and the plate spring 46 is disposed beneath the carriage-L 41, the guiding shaft 45 and the carriage-R 43. Also, there are two securing components 47b and 47a respectively disposed on the bottom surface of the carriage-L 41 and the carriage-R 43 for holding two ends of the spring plate 46. Therefore, the carriage-L 41 and carriage-R 43 are subjected to the elastic force of the plate spring 46, so as to allow the pivoting of the carriage-L 41 and carriage-R 43 on the guiding shaft 45. When the optical scanning module 20 is loaded onto the carrying apparatus, the carriage-L 41 and the carriage-R 43 rotatably assembled on the guiding shaft 45 will be forced to moved upward due to the elastic force of the plate spring 46, thereby lifting the optical scanning module 20 up and against the transparent platen (not shown in FIG. 4).

Moreover, for maintaining the position of the optical scanning module 20 on the carrying apparatus, the holding means 48a and 48b are further disposed on the carriage-R 43 and the carriage-L 41, respectively. In the illustrated configuration, the holding means 48a and 48b have a cross section shaped as “L”, and perpendicularly attach to the sides of the optical scanning module 20. Noted that the holding means 48a and 48b are able to slightly wiggle on the carriages. The holding springs 481a and 481b, fixed to the barrier plates 483a and 483b by each end, are connected to the holding means 48a and 48b, respectively. When the carriage-L 41 and the carriage-R 43 are pivoted on the guiding shaft 45, the angle between the holding means 48a/48b and optical scanning module 20 changes; meanwhile, the holding springs 481a and 481b function as the buffers. The elastic force of the holding springs 481a and 481b makes the holding means 48a and 48b clutch the optical scanning module 20 under any condition; for example, an angle occurs between the holding means 48a/48b and optical scanning module 20. Also, the elastic recovery force of the holding springs 481a and 481b provide the tendency of the holding means 48a and 48b for going back to the original positions (i.e. perpendicularly touching the sides of the optical scanning module 20).

Accordingly, the plate spring 46 is used as the carriage control means in the third embodiment, and the elastic force of the plate spring 46 provides an upward supporting force for pivoting the carriage-L 41 and the carriage-R 43 on the guiding shaft 45.

Fourth Embodiment

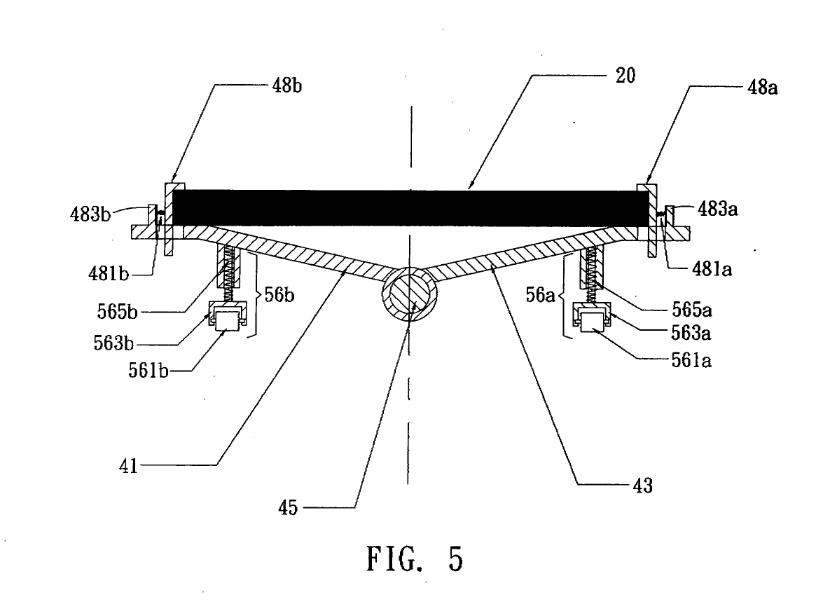

FIG. 5 schematically illustrates a disassembled view of the carrying apparatus and the optical scanning module according to the fourth embodiment of the invention. Components common to both FIG. 4 and FIG. 5 retain the same numeric designation. The carrying apparatus of the fourth embodiment is substantially identical to that of the third embodiment except the component for providing an upward force to the carriages is replaced. In the fourth embodiment, the idle pulley apparatus 56a and 56b, respectively disposed under the carriage-R 43 and carriage-L 41, are used as the carriage control means.

In the illustrated configuration, the idle pulley apparatus 56a comprises an idle pulley 561a for being able to rolling in the scanner (ex: rolling on the bottom housing of scanner), an idle pulley housing 563a coupled to the idle pulley 561a, and an idle pulley spring 565a connected to carriage-R 43 and the idle pulley housing 563a. The idle pulley apparatus 56b, having the components identical to that of the idle pulley apparatus 56a, comprises an idle pulley 561b, an idle pulley housing 563b and an idle pulley spring 565b.

During a scanning operation, the carrying apparatus with the scanning module 20 is driven to move along the guiding shaft 45, and the idle pulleys 561a and 561b are simultaneously rolling in the scanner. Meanwhile, the carriage-R 43 and carriage-L 41 are subjected to the elastic force of the idle pulley springs 565a and 565b, so that the optical scanning module 20 is raised up and against the transparent platen by the carriage-R 43 and carriage-L 41.

Accordingly, the idle pulley apparatus 56a and 56b are used as the carriage control means in the fourth embodiment, and the elastic force of the idle pulley springs 565a and 565b provide the upward supporting force for lifting the carriage-L 41 and the carriage-R 43 up.

Although the carrying apparatus illustrated in the third and fourth embodiments comprises two carriage pieces (i.e. the carriage-L and the carriage-R), it is, of course, understood that the carriage-L and the carriage-R could be pivotably connected to a carriage base as illustrated in the first and second embodiments.

While the invention has been described by way of examples and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A scanner, comprising:
a platen for placing a to-be-scanned document;
an optical scanning module, disposed under the platen for scanning and acquiring an scanned image of the to-be-scanned document; and
a carrying apparatus for holding the optical scanning module and moving backward and forward in the scanner, at least comprising:
a first carriage;
a second carriage, pivotably connected to the first carriage; and
a carriage control component, the first carriage and the second carriage pivotably connected by the carriage control device, wherein the carriage control component provides an upward supporting force to the fist carriage so as to lift the optical scanning module upward and against the platen during a scanning operation.

2. The scanner according to claim 1, wherein the carrying apparatus further comprises a third carriage rotatably connected to a rotation part of the second carriage, while the first carriage and the second carriage are pivotably connected by another rotation part.

3. The scanner according to claim 2, wherein the carrying apparatus comprises a first carriage control component positioned below the first carriage and the second carriage, and a second carriage control component positioned below the second carriage and the third carriage.

4. The scanner according to claim 1, wherein the carriage control component is a plate spring.

5. The scanner according to claim 4, wherein both of the first carriage and the second carriage have a securing component beneath for holding two ends of the plate spring.

6. The scanner according to claim 1, wherein the carriage control component is a torsion spring.

7. The scanner according to claim 6, wherein the first carriage and the second carriage are pivotably connected by an axial rod on which the torsion spring is mounted.

8. The scanner according to claim 6, wherein a fixing pin is disposed at one of the first carriage and the second carriage for mounting the torsion spring

9. The scanner according to claim 1, wherein the carrying apparatus further comprises a fixing means for maintaining the optical scanning module on the carrying apparatus.

10. The scanner according to claim 9, wherein the fixing means comprises:
at least a rib, formed on a housing of the optical scanning module; and
at least a notch, formed on the carrying apparatus for relatively receiving the rib so as to maintaining the optical scanning module on the carrying apparatus.

11. The scanner according to claim 9, wherein the fixing means comprises:
two holding means, disposed at each ends of the first carriage and the second carriage for holding the optical scanning module.

12. The scanner according to claim 11, wherein each holding means is connected to a buffering spring.

13. A scanner, comprising:
a platen for placing a to-be-scanned document;
an optical scanning module, disposed under the platen for scanning and acquiring an scanned image of the to-be-scanned document; and
a carrying apparatus for holding the optical scanning module and moving backward and forward in the scanner, at least comprising:
a first carriage;
a second carriage, pivotably connected to the first carriage; and
an idle pulley apparatus, having an elastic force and disposed under each of the first carriage and the second carriage for providing an upward force to the first carriage and the second carriage, thereby lifting the optical scanning module upward and against the platen during a scanning operation.

14. The scanner according to claim 13, wherein the idle pulley apparatus has an idle spring upwardly against each of the first carriage and the second carriage.

15. The scanner according to claim 13, wherein the carrying apparatus further comprises a fixing means for maintaining the optical scanning module on the carrying apparatus.

16. The scanner according to claim 15, wherein the fixing means comprises:
at least a rib, formed on a housing of the optical scanning module; and
at least a notch, formed on the carrying apparatus for relatively receiving the rib so as to maintaining the optical scanning module on the carrying apparatus.

17. The scanner according to claim 15, wherein the fixing means comprises:
two holding means, disposed at each ends of the first carriage and the second carriage for holding the optical scanning module.

18. The scanner according to claim 17, wherein each holding means is connected to a buffering spring.
